(19) United States
(12) Patent Application Publication
(10) Pub. No.: US 2023/0294751 A1
(43) Pub. Date: Sep. 21, 2023

(54) STEERING COLUMN FOR A MOTOR VEHICLE

(71) Applicants: thyssenkrupp Presta AG, Eschen (LI); thyssenkrupp AG, Essen (DE)

(72) Inventors: Sebastian HUBER, Goefis (AT); Tim BAYER, Luechingen (CH)

(73) Assignees: thyssenkrupp Presta AG, Eschen (LI); thyssenkrupp AG, Essen (DE)

(21) Appl. No.: 18/121,439

(22) Filed: Mar. 14, 2023

(30) Foreign Application Priority Data
Mar. 15, 2022 (EP) 22162223.6

(51) Int. Cl. B62D 1/185; B62D 1/181

(52) U.S. Cl. CPC B62D 1/185; B62D 1/181

(57) ABSTRACT

A steering column for a motor vehicle comprises a covering unit. A steering spindle is rotatably supported about a longitudinal axis which extends in a longitudinal direction. At least three covering elements can be displaced in a telescope-like manner in a longitudinal direction and which comprise at least one internal covering, an external covering and an intermediate element. A motorised displacement drive includes a first spindle drive arranged between the internal covering and the intermediate element and a second spindle drive arranged between the intermediate element and the external covering engages with the covering elements. The first spindle drive has a first threaded spindle which engages a first spindle nut and is selectively driven in rotation relative thereto by a drive unit. The second spindle drive has a second threaded spindle which engages a second spindle nut that can be driven in rotation relative thereto by the drive unit.

### CROSS REFERENCE TO RELATED APPLICATION

This application is a U.S. Non-Provisional that claims priority to European Patent Application No. EP 22162223.6, filed Mar. 15, 2022, the entire content of which is incorporated herein by reference.

### FIELD

The present disclosure generally relates to a steering column for a motor vehicle.

### BACKGROUND

A steering column for a motor vehicle has a covering unit in which a steering spindle is rotatably supported about the longitudinal axis thereof, to the rear end of which steering spindle facing the driver in the travel direction, for example, a steering wheel is fitted as a manual steering input means. The covering unit is retained by a carrier unit which is fixed to the vehicle body. By displacing the covering unit relative to the carrier unit, the steering wheel position relative to the vehicle body can be adjusted.

A longitudinal displacement, in which the steering wheel can be displaced backwards or forwards in the longitudinal direction relative to the driver position, is allowed in a generic steering column by a telescope-like configuration of the covering unit and the steering spindle. Furthermore, the steering column can be pushed together in the longitudinal direction in the event of a crash, whereby the steering column is effectively prevented from being introduced inside the passenger compartment and from resulting in injuries to the occupants.

The covering unit of a generic steering column has at least three covering elements which can be moved in a telescope-like manner relative to each other and which are also synonymously referred to as telescope-like elements or covering tubes. For example, a three-fold or multiple-fold telescope-like arrangement may be provided, with at least three or more covering elements which are nested in a telescope-like manner one inside the other. They comprise at least one internal covering element which is also referred to as an internal covering, internal covering element or tube and which is introduced coaxially into at least one central covering element or intermediate element which is in turn introduced in a telescope-like manner into an external covering element, which is also referred to as an external covering, external covering element or tube. In that the covering tubes are moved apart or together in the longitudinal direction, the covering unit and therefore the steering column can be shortened or lengthened.

A motorised displacement drive which has a spindle drive which is arranged between covering elements which can be displaced relative to each other and which has a threaded spindle which is axially supported on one covering element and which engages in a spindle nut which is axially supported on another covering element which can be displaced relative thereto is used to displace the steering column. As a result of the motorised drive unit, the threaded spindle and the spindle nut can be rotatingly driven by an electric motor relative to each other about the thread axis or spindle axis in order to move the covering elements axially towards each other or to move them apart from each other depending on the direction of rotation of the drive.

In order to displace a multiple telescope-like arrangement, it is known from US 2019/0210633 A1 to provide a first and a second spindle drive which each engage with two covering elements which are displaceable relative to each other. A flexibly predeterminable, synchronised displacement thereby becomes possible. However, a disadvantage is that the two spindle drives are constructed in a complex manner and, regardless of the displacement state, take up a structural space which is relatively large and which is fixedly predetermined by the lengths of the threaded spindles. This may be problematic particularly in steering systems for self-driving vehicles in which during autonomous driving operation the steering column is intended to be able to be moved together in a storage position outside the operating region so as to take up as little space as possible.

Thus, a need exists to improve the possible uses and to allow a reduced structural space.

### BRIEF DESCRIPTION OF THE FIGURES

FIG. 1 is a front perspective view of a steering column according to an example of the invention in an extended displacement state.

FIG. 2 is a rear perspective view of the steering column according to FIG. 1.

FIG. 3 is an axial view of the steering column according to FIGS. 1 and 2.

FIG. 4 is a side view of the covering unit of the steering column according to FIG. 1 in an extended displacement state (operating position).

FIG. 5 is a side view of the covering unit as in FIG. 4 in the moved-together displacement state (storage position).

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to a steering column for a motor vehicle, comprising a covering unit, in which a steering spindle is rotatably supported about a longitudinal axis which extends in a longitudinal direction, and which has at least three covering elements which can be displaced in a telescope-like manner in a longitudinal direction and which comprise at least one internal covering, an external covering and an intermediate element which is arranged therebetween, wherein a motorised displacement drive, which has a first spindle drive which is arranged between the internal covering and the intermediate element and a second spindle drive which is arranged between the intermediate element and the external covering, engages with the covering elements, wherein the first spindle drive has a first threaded spindle which engages in a first spindle nut and which can be driven in rotation about the thread axis relative thereto by a drive unit, and the second spindle drive has a second threaded spindle which engages in a second spindle nut and which can be driven in rotation relative thereto by the drive unit.

In a steering column for a motor vehicle comprising a covering unit, in which a steering spindle is rotatably supported about a longitudinal axis which extends in a longitudinal direction, and which has at least three covering elements which can be displaced in a telescope-like manner in a longitudinal direction and which comprise at least one internal covering, an external covering and an intermediate element which is arranged therebetween, wherein a motorised displacement drive, which has a first spindle drive which is arranged between the internal covering and the intermediate element and a second spindle drive which is arranged between the intermediate element and the external covering, engages with the covering elements, wherein the first spindle drive has a first threaded spindle which engages in a first spindle nut and which can be driven in rotation about the thread axis relative thereto by a drive unit, and the second spindle drive has a second threaded spindle which engages in a second spindle nut and which can be driven in rotation relative thereto by the drive unit, there is provision according to the invention for the first spindle nut and the second threaded spindle to be connected to each other coaxially in a rotationally secure manner in order to form a thread unit which can be rotationally driven by the drive unit and which is axially supported relative to the drive unit.

According to the invention, the thread unit forms a combined threaded spindle/spindle nut unit in which the first spindle nut and the second threaded spindle are functionally combined. In this case, the internal thread of the first spindle nut and the external thread of the second threaded spindle are arranged coaxially relative to the common thread axis which is accordingly identical to the spindle axes of both spindle drives. This integrated thread unit can be rotatingly driven about the thread axis by the drive unit relative to the first threaded spindle and the second spindle nut and is axially supported in this case with respect to the thread axis on the drive unit.

There are also included such embodiments in which the first and second spindle drives are changed with respect to the internal and external coverings, that is to say, the first spindle drive is arranged between the external covering and intermediate element, or in which a spindle drive engages between two intermediate elements.

An advantage of the invention is that the two thread drives which are formed by the first and second threaded spindles and spindle nuts are synchronously driven by rotating drive of the threaded element according to the invention. Consequently, the synchronised displacement of at least three covering elements which are connected by the spindle drives is enabled without any additional synchronisation devices. Furthermore, the drive-related connection of the integrated threaded element to the drive unit is possible with less complexity than with the separate spindle drives in the prior art. Accordingly, the displacement drive can advantageously be configured in a more compact manner and with less complexity. In that only one integrated thread unit can be rotatingly driven, a structurally simple construction and a high level of functional and operational reliability can be achieved.

The advantageous, variably adaptable configuration possibilities are brought about particularly in that the first spindle drive is in the form of a so-called immersion spindle drive, in which the first spindle nut is rotatingly driven and the threaded spindle which engages therein is fixed in a rotationally secure manner to the covering element which is intended to be displaced relative to the drive unit and the second spindle drive is in the form of a so-called rotation spindle drive, in which the second threaded spindle is rotatingly driven and the spindle nut which is screwed thereon is fixed in a rotationally secure manner to the covering element which is intended to be displaced relative to the drive unit. The drive unit is fixed to a third covering element which is axially fixed with respect to the two mentioned displaceable covering elements and can selectively drive the threaded element according to the invention in both directions of rotation, whereby both spindle drives are necessarily driven synchronously.

The drive unit is preferably fitted to the covering unit, preferably to one of the covering elements. An electric motor may in this case be connected via a gear mechanism or also directly to the thread unit according to the invention in order to drive it rotatingly relative to the covering unit about the thread axis.

The covering unit has at least three telescope-like covering elements, that is to say, an external covering, an internal covering and at least one intermediate covering which is arranged therebetween in a nested manner and which forms an intermediate element. In this case, it is preferable for the external covering to be retained by a carrier unit which can be connected to the body. As a result of the telescope-like displacement, consequently, the internal covering and the intermediate covering or all the intermediate coverings can be displaced relative to the carrier unit. In this case, it is particularly preferable for the motorised drive unit to be fitted to the intermediate covering or intermediate element which can be displaced relative to the carrier unit. A significant aspect in this case is that the first threaded spindle forms a fixed threaded spindle of an immersion spindle drive which extends, for example, between the intermediate element (intermediate covering) to which the drive unit is fitted and the first covering which is movable relative thereto, for example, the internal covering, and the second threaded spindle forms the rotatingly drivable threaded spindle of a rotary spindle drive which extends between the intermediate element (intermediate covering) to which the drive unit is fitted and the other covering which is movable relative thereto, for example, the external covering, and in this case engages in a spindle nut which is securely fitted to the external covering. As a result of the rotating drive of the thread unit according to the invention, the intermediate element to which the drive unit is fitted is displaced relative to the internal covering and external covering and therefore also moved relative to the carrier unit. A significant aspect for this structurally advantageous kinematic arrangement is in particular the drive unit being fitted to the intermediate element which can be displaced relative to the external covering which is retained by the carrier unit.

The drive unit which is fitted to the intermediate element is arranged outside this intermediate element. Accordingly, the thread unit according to the invention and the first threaded spindle which engages therein are also arranged outside the intermediate element, wherein the thread axis extends with radial spacing parallel with the longitudinal axis of the covering unit.

The thread axis of the coaxial internal and external thread of the thread unit preferably extends parallel with the longitudinal axis of the covering unit.

Preferably, the internal thread of the first spindle nut can be arranged inside the external thread of the second threaded spindle. In this case, the internal thread can be arranged in the region of the axial extent of the second threaded spindle or axially adjacent thereto. For example, the spindle nut can be positioned coaxially at the front side in an axial end region of the threaded spindle. This promotes a compact construction type.

There may preferably be provision for the second threaded spindle to be in the form of a hollow spindle, in which the first threaded spindle can be received axially. The hollow spindle has an axial passage having an opening cross section which is greater at least partially than the external cross section of the external thread of the first threaded spindle. This spindle can thereby be screwed through the first spindle nut when the covering unit is moved together and can be introduced axially into the second threaded spindle with the portion thereof which extends out of the spindle nut in this case. In this manner, the first threaded spindle can be stored practically inside the longitudinal extent of the hollow second threaded spindle so that, in a completely moved-together storage state, both spindle drives can be received within a relatively short storage length which can substantially correspond to the length of the second threaded spindle. This is an advantage over the mentioned prior art in which the minimal storage length is also at least the sum of the lengths of both threaded spindles in the moved-together storage state.

An advantageous configuration may make provision for the thread unit to be constructed integrally. In this case, at least the first spindle nut and the second threaded spindle can be in the form of an integral component which has the internal thread of the first spindle nut and the external thread of the second threaded spindle. Advantages are a compact construction type with a relatively low production complexity and a high level of operational reliability.

It is preferably possible for the thread unit to be connected to a gear wheel of the drive unit. In this case, the drive unit has an electric motor, the motor shaft of which is connected at the input side to a gear mechanism which is connected at the output side to the thread unit in order to rotatingly drive it relative to the covering unit about the thread axis. In that the thread unit is directly connected to an output-side gear mechanism member, such as, for example, a toothed wheel, worm gear, belt wheel or the like, or has such a member, an efficient drive and a construction type, which saves construction space and which is integrated in the drive unit, can advantageously be achieved.

In a preferred embodiment, the gear wheel can be constructed in one piece or integrally with the thread unit. For example, the thread unit can have, preferably in the region of the first spindle nut, at the external circumference thereof a toothed ring which can be engaged with a driven gear means of the gear mechanism. For example, an integrated worm gear in which a motor-driven worm engages can thereby be constructed. An efficient production, a small necessary structural space and a low weight are thereby enabled.

It may be advantageous for the thread unit to have a plastics material. The first spindle nut and/or the second threaded spindle can each be constructed completely or partially from a plastics material, preferably at least in the region of the thread. It is further possible also to construct a gear wheel which is connected to the thread unit at least partially from plastics material, for example, in the region of a toothed ring. One advantage is that, as a result of a plastics material in a material pairing with a metal or an additional plastics material, favourable sliding properties and a low friction can be achieved, whereby a smooth-running and low-play displacement is enabled. Furthermore, a long-term low-friction and substantially maintenance-free operation can be ensured.

Preferably, the production can be carried out using plastics injection-moulding from a thermoplastic polymer. Preferably, the first spindle nut and/or the second threaded spindle can be produced as an integral injection-moulded component. In order to be in the form of a gear wheel, for example, there can be constructed a toothed ring which can also be integrally integrated in the injection-moulding or which can be injection-moulded on the threaded element. A weight-saving construction type and advantageous rational production are thereby enabled.

The thread unit can have a massive plastics component, preferably an injection-moulded component, or a core element which may have, for example, a metal material and which is at least partially surrounded by a plastics material or coated therewith, for example, in the region of the thread and/or a gear wheel. Such a core element can preferably be over-moulded with the plastics material.

In order to reduce the friction, the surface of the thread unit can be configured so as to reduce friction at least in the region of the thread and/or a gear wheel. To this end, for example, permanently self-lubricating coatings, hard-material coatings or the like can be applied and, alternatively or additionally, lubricant reservoirs can be provided, for example, lubricant pockets which are formed in the surfaces, or the like, and which can be filled with grease or solid lubricant.

In a preferred embodiment, there may be provision for the drive unit to be fitted axially securely to an intermediate element. The thread unit according to the invention can be rotatingly driven by the drive unit and supported in an axially supported manner. The first spindle nut forms together with the first threaded spindle an immersion spindle drive for displacing a covering element which is axially adjacent to the intermediate element, for example, the internal coating, relative to the intermediate element. The second threaded spindle forms together with the second spindle nut a rotation spindle drive for displacing another covering element which is adjacent to the intermediate element in an axially opposed manner, for example, the external covering, relative to the intermediate element. During rotating driving of the thread unit, a simultaneous axial displacement of the external covering can be brought about relative to the intermediate element, and of the intermediate element relative to the internal covering. In this case, the compact structural shape according to the invention is advantageous.

With the same functional principle, the second spindle nut may be fixed alternatively to the internal covering or to an additional intermediate element and accordingly the first threaded spindle may be fixed to the external covering or to an additional intermediate element.

It is preferable for the first spindle drive and the second spindle drive to have opposite threads. For example, the first threaded spindle and spindle nut may have a right-handed thread and the second threaded spindle and spindle nut may have a left-handed thread. With right-rotating driving of the thread unit—when viewed in an axial direction from the thread unit towards the secand spindle nut in the clockwise direction—the second spindle nut is then moved towards the thread unit and the first threaded spindle is also moved axially counter thereto towards the thread unit. Accordingly, the external covering and internal covering are moved axially relative to each other, towards the drive unit, so that the covering elements are moved together in the longitudinal direction, whereby the covering unit is shortened. An advantageously simple, robust and functionally reliable construction can thereby be achieved.

In that the second threaded spindle is preferably in the form of a hollow spindle, the first threaded spindle can be introduced axially therein during the movement together so that in the moved-together state of the covering unit the two spindle drives can also be stored one in the other in a compact manner.

As a result of a transposed rotating drive direction, the second spindle nut and the first threaded spindle can be axially moved in the opposite direction away from the thread unit and therefore away from the drive unit so that the covering elements are moved apart from each other in the longitudinal direction.

The arrangement of right-handed and left-handed threads can be changed for the same effect with respect to the spindle drives.

It is possible for the first spindle drive and the second spindle drive to have different thread pitches. The thread pitch determines the displacement path in accordance with the relative rotation of the threaded spindle and spindle nut and accordingly the displacement speed in accordance with the speed of the drive. In this case, a great thread pitch corresponds to a relatively large linear displacement path and a high displacement speed and accordingly a smaller thread pitch corresponds to a smaller displacement path and a lower displacement speed but with a higher linear displacement force. In that the thread unit according to the invention comprising the first spindle nut and the second threaded spindle is rotatingly driven by the drive unit about a predetermined rotation angle at a predetermined speed, different displacement paths and displacement speeds can be achieved by the different thread pitches for the two spindle drives for a predetermined drive. A type of asymmetrical displacement which can be individually adapted can thereby advantageously be brought about. For example, covering elements with a larger cross section can be moved further apart by a first spindle drive during displacement by a first displacement drive relative to each other than covering elements with a relatively smaller cross section by a second displacement drive in order to achieve the highest possible rigidity of the extended telescope-like arrangement. Alternatively, vice versa, a relatively more rapid and greater displacement of covering elements with a smaller cross section is possible, whereby the masses moved during displacement can be reduced. This allows a more rapid displacement and/or a smaller necessary drive power of the drive unit.

It is possible for a manual steering handle to be fitted to the steering spindle. This may be a steering wheel, for example, which can be fixed in a rotationally secure manner to a connection portion at the rear end portion of the steering spindle.

It may be advantageous for at least one of the spindle drives to be configured in a self-locking manner. This can be achieved in that at least one of the threads is configured to be self-locking. It can thereby advantageously be ensured that no displacement of the adjusted steering column adjustment is also carried out as a result of high axial forces which act on the displacement drive.

In the various Figures, identical members are always provided with the same reference numerals and are therefore generally also set out or mentioned only once.

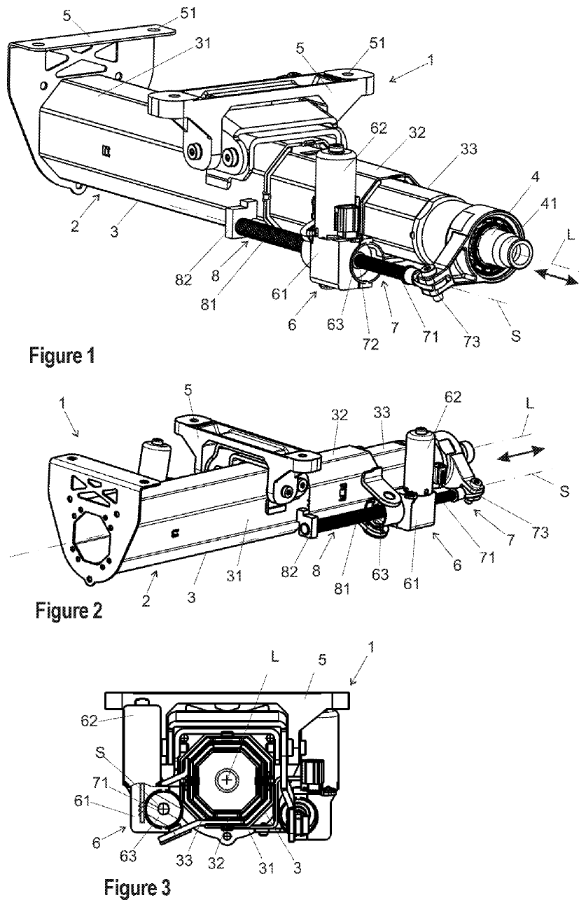

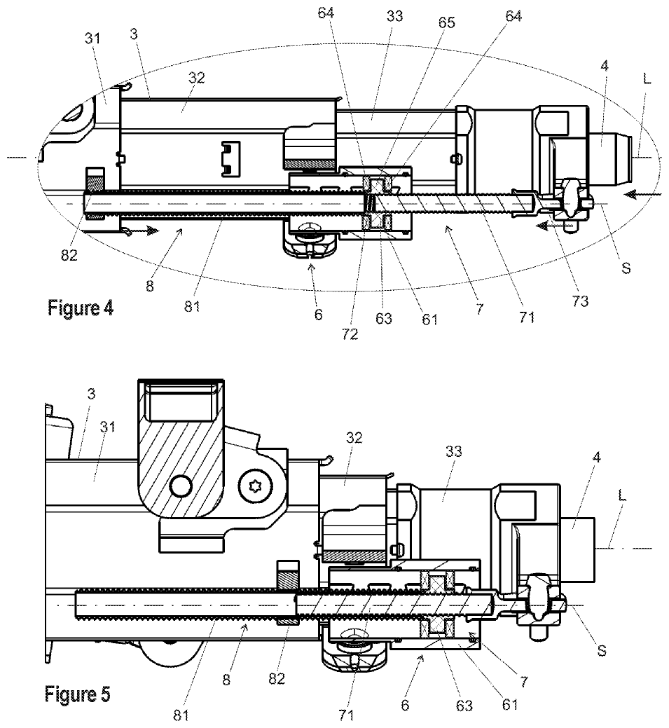

FIGS. 1, 2 and 3 show a steering column 1 according to the invention, in an at least partially extended operating position (FIGS. 1 and 2) and in a retracted storage position (FIG. 3). The viewing direction is illustrated obliquely from the rear and above with respect to the travel direction (FIG. 1) or obliquely from the front (FIG. 2) or in the longitudinal direction, that is to say, axially (FIG. 3). FIG. 4 shows a side view in an extended operating position and FIG. 5 shows a side view in a moved-together storage position.

The steering column 1 has an adjustment unit 2. This unit comprises a covering unit 3 which has an external covering 31, which is also referred to as an external covering tube 31, an intermediate covering 32, which is also referred to synonymously as an intermediate element 32, and an internal covering 33 which is also referred to as an internal covering tube 33. They form covering elements 31, 32 and 33 which are arranged so as to be axially displaceable coaxially in a telescope-like manner one inside the other, in the axial direction of a longitudinal axis L, as indicated with a double-headed arrow.

A steering spindle 4 which has in the rear end region thereof a connection portion 41 for fitting a manual steering handle which is not illustrated, for example, a steering wheel, is rotatably supported about the longitudinal axis L in the covering unit 3.

The steering spindle 4 can also be constructed in a telescope-like manner for longitudinal displacement. It is also conceivable and possible for the steering spindle 4 not to be constructed in a continuous manner axially through the covering unit 3 but instead for it to cooperate with electronic rotary sensors of a steer-by-wire steering system, wherein the steering spindle does not have any direct mechanical connection with respect to the steerable wheels. These rotary sensors can preferably be received in the covering unit 3, for example, in the internal covering 33, in order to produce electrical control signals in accordance with a manual steering input in order to control electrical steering actuators which cooperate with the steerable wheels.

The covering unit 3 is retained in a two-piece carrier unit 5 which has fixing means 51 for fitting to a vehicle body which is not illustrated.

A displacement drive 6 according to the invention for longitudinal displacement in a telescope-like manner has a drive unit 61 which is fixed to the intermediate covering 32 and supported in an axial direction. The drive unit has an electric motor 62.

The displacement drive 6 has a first spindle drive 7 and a second spindle drive 8.

Details of the displacement drive 6 can be taken from FIGS. 4 and 5, in which the drive is illustrated as a longitudinal section.

The first spindle drive 7 is in the form of a so-called immersion spindle drive and comprises a first threaded spindle 71 which extends along a thread axis S which is also referred to as the spindle axis S and which preferably extends parallel with the longitudinal axis L. The threaded spindle 71 engages in the internal thread of a first spindle nut 72 which is securely connected according to the invention to a threaded element 63, preferably in a state constructed in one piece or integrally.

The threaded element 63 is supported in the drive unit 61 so as to be axially supported (with respect to the thread axis S) so as to be able to be rotationally driven about the thread axis S by the motor 62.

The threaded spindle 71 is axially supported and fixed on the internal covering 33 in a rotationally secure manner with respect to the covering unit 3 in the free end region via a connection element 73.

The second spindle drive 8 is in the form of a so-called rotation spindle drive and comprises a second threaded spindle 81 which also extends along the thread axis S. The threaded spindle 81 is connected to the threaded element 63 coaxially in a rotationally secure manner and can therefore preferably be constructed in one piece or integrally. Accordingly, the first spindle nut 72 and the second threaded spindle 81 are connected to each other in a rotationally secure and axially fixed manner according to the invention in order to form the thread unit 63 coaxially with respect to the thread axis S. The thread unit 63 can be rotationally driven by the drive unit 61 about the thread axis S and is in this case axially supported relative to the drive unit 61.

In the region projecting axially from the threaded element 63, the second threaded spindle 81 has an external thread which engages in a second spindle nut 82. This nut is axially supported in the external covering 31 and fixed in a rotationally secure manner.

FIG. 4 clearly shows how the internal thread of the first spindle nut 72 is constructed coaxially inside the threaded element 63. The first spindle nut 72 is fixedly fitted axially to the second threaded spindle 81 at the front side, preferably in an integral construction, for example, made from a plastics material.

The threaded element 63 is axially supported rotatably between pressure bearings 64 in the drive unit 61. These pressure bearings 64 may be in the form of roller bearings, for example, in the form of angular ball bearings in an X-like arrangement or O-like arrangement.

At the external circumference thereof, preferably in the region of the first spindle nut 72 which is supported between the pressure bearings 64, the threaded element 63 has a toothed ring 65. It is thereby in the form of a gear wheel, in which a gear wheel which is not illustrated in detail and which can be driven by the motor 62, for example, a worm, engages in a gear-like manner. The toothed ring 65 can preferably also be constructed integrally with the threaded element, for example, by a plastics over-moulding operation.

The function is explained with reference to FIGS. 4 and 5, wherein FIG. 4 shows an operating position in which the covering elements 31, 32, 33 are extended in the longitudinal direction, and FIG. 5 shows a storage position, in which the covering elements 31, 32, 33 are moved together to a maximum extent.

The two spindle drives 7 and 8 have opposite threads, for example, the first spindle drive 7 can have a left-handed thread and the second spindle drive 8 can have a right-handed thread, or vice versa.

The second threaded spindle 81 is in the form of a tubular hollow spindle which is positioned coaxially against the first spindle nut 72. In this case, the open internal diameter of the second threaded spindle 81 is greater than the external diameter of the external thread of the first threaded spindle 71. The first threaded spindle 71 can thereby be introduced coaxially into the second threaded spindle 81.

If, in the extended displacement state, the thread unit 63 is rotationally driven by the motor 62, for example, axially, in FIGS. 4 and 5 when viewed from the right in the clockwise direction, the second threaded spindle 81 is screwed into the second spindle nut 82. The external covering 31 is thereby moved towards the drive unit 61 and the intermediate element 32, as indicated with the arrow which is directed to the right in FIG. 4. At the same time, the first threaded spindle 7 is screwed into the rotating first spindle nut 72 and moves together with the internal covering 33 towards the drive unit 61 and the intermediate element 61 which is connected thereto, as indicated with the arrow which is directed to the left.

Accordingly, the rotating drive of the threaded element 63 according to the invention brings about from the extended displacement state according to FIG. 4 a simultaneous actuation of the two axially oppositely acting spindle drives 7 and 8 so that the covering elements 31, 32, 33 are moved together in a synchronised manner.

The storage position, which is moved together to the maximum extent, is shown in FIG. 5. It can be seen therein how the first threaded spindle 71 is introduced practically completely axially into the second threaded spindle 81 which is in the form of a hollow spindle. An advantageous, particularly compact storage is thereby enabled.

It is possible for the thread of the spindle drives 7 and 8 to have the same thread pitch or also to be able to have different thread pitches in order to achieve different displacement paths between the covering elements 31 and 32 or 32 and 33 for a given rotating drive of the threaded element 63.

The threaded element 63 can have a plastics material, including the first spindle nut 72, the second threaded spindle 81 and/or the toothed ring 65, or can be made completely from plastics material, for example, in the form of a plastics injection-moulded component made from a thermoplastic polymer. The first threaded spindle 71 and the second spindle nut 82 can be made from a metal material, for example, from steel. An advantageously low-friction friction pairing can thereby be achieved.

It is inventively significant that the drive unit 61 is fitted to the intermediate covering 32 which can be displaced relative to the external covering 31 and therefore also relative to the carrier unit 5. Consequently, the drive unit 61 is moved relative to the carrier unit 5 during displacement.

### LIST OF REFERENCE NUMERALS

1 Steering column
2 Adjustment unit
3 Covering unit
31 External covering (covering element)
32 Intermediate element (covering element)
33 Internal covering (covering element)
4 Steering spindle
5 Carrier unit
51 Fixing means
6 Displacement drive
61 Drive unit
62 Motor
63 Threaded element
64 Pressure bearing
65 Toothed ring
7 First spindle drive
71 First threaded spindle
72 First spindle nut
73 Connection element
8 Second spindle drive
81 Second threaded spindle
82 Second spindle nut
L Longitudinal axis
S Thread axis (spindle axis)

What is claimed is:

1. A steering column for a motor vehicle, the steering column comprising:
a covering unit, in which a steering spindle is rotatably supported about a longitudinal axis which extends in a longitudinal direction, and which has at least three covering elements which are selectively displaced in a telescope-like manner in a longitudinal direction and which comprise at least one internal covering, an external covering and an intermediate element which is arranged therebetween; and
a motorised displacement drive, which has a first spindle drive which is arranged between the internal covering and the intermediate element and a second spindle drive which is arranged between the intermediate element and the external covering, engages with the covering elements, wherein the first spindle drive has a first threaded spindle which engages in a first spindle nut and which can be driven in rotation relative thereto by a drive unit, and the second spindle drive has a second threaded spindle which engages in a second spindle nut and which can be driven in rotation relative thereto by the drive unit;
wherein the first spindle nut and the second threaded spindle are connected to each other coaxially in a rotationally secure manner in order to form a thread unit which is rotationally driven by the drive unit and which is axially supported relative to the drive unit.

2. The steering column according to claim 1 wherein the internal thread of the first spindle nut is arranged inside the external thread of the second threaded spindle.

3. The steering column according to claim 2 wherein the second threaded spindle is in the form of a hollow spindle, in which the first threaded spindle is received axially.

4. The steering column according to claim 3 wherein the thread unit is constructed integrally.

5. The steering column according to claim 4 wherein the thread unit is connected to a gear wheel of the drive unit.

6. The steering column of claim 5 wherein the thread unit has a plastics material.

7. The steering column according to claim 6 wherein the drive unit is fitted axially secured to an intermediate element.

8. The steering column according to claim 7 wherein the first spindle drive and the second spindle drive have opposite threads.

9. The steering column according to claim 7 wherein the first spindle drive and the second spindle drive have different thread pitches.

10. The steering column according to claim 1, further comprising a manual steering handle fitted to the steering spindle.

11. The steering column of claim 1 wherein at least one of the spindle drives is configured in a self-locking manner.
